(19) United States
(12) Patent Application Publication
(10) Pub. No.: US 2003/0233624 A1
(43) Pub. Date: Dec. 18, 2003

(54) Method for predicting the degradation of an integrated circuit performance due to negative bias temperature instability

(75) Inventors: Vijay K. Reddy, Plano, TX (US); Srikanth Krishnan, Richardson, TX (US)

Correspondence Address: TEXAS INSTRUMENTS INCORPORATED, P O BOX 655474, M/S 3999, DALLAS, TX, 75265

(73) Assignee: Texas Instruments Incorporated, Dallas, TX

(21) Appl. No.: 10/171,499

(22) Filed: Jun. 13, 2002

(51) Int. Cl. G06F 17/50

(52) U.S. Cl. 716/4

(57) ABSTRACT

A method is provided of correlating integrated circuit NBTI-induced performance degradation to discrete transistor NBTI-induced performance degradation and using that correlation to estimate integrated circuit degradation over time using test results based on a discrete transistor. Because discrete transistors are easier and cheaper to test, the technique described herein makes it easier, faster and cheaper to estimate the degradation of an integrated circuit over time than testing the integrated circuit itself.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to predicting performance degradation of an integrated circuit. More particularly, the invention relates to predicting performance degradation of an integrated circuit as caused by negative bias temperature instability (NBTI). More particularly, the invention relates to predicting parameter drift of an integrated circuit using NBTI degradation data based on an individual transistor.

2. Background Information

Semiconductor devices (processors, etc.) are characterized by a number of different parameters such as maximum operating frequency (the maximum clock frequency at which the device can operate within its rating). Although the various electrical parameters that characterize the operation of a semiconductor device are known at the time of manufacturing, some, or all, of these parameters may vary over time. Such parameter change over time is referred to as “drift.”

Parameter drift has various causes including “channel hot carriers” (CHC) and “negative bias temperature instability” (NBTI). Channel hot carriers generally refer to, in the context of an NMOS transistor for example, electrons that become trapped in the transistor's gate oxide layer due to a relatively large electric field. NBTI refers to a parameter shift observed in a transistor or a circuit when a negative bias is applied to the gate of a transistor. As a result of NBTI, an integrated circuit's (IC) maximum operating frequency can decrease over time. NBTI can also cause an integrated circuit's minimum operating voltage to increase over time.

A company that makes and sells products containing integrated circuits (ICs) may desire for their products to function as rated over a particular period of time. Cell phone, computer, or pager manufacturers, for example, each may desire for their products to last for a predetermined period of time (e.g., 2 years, 5 years, 10 years). The life of the product will be, at least to a certain extent, a function of the life of the semiconductor devices contained therein. As such, it is important for the product manufacturers to know the useful rated life of the ICs.

It is generally known that the rated life of an IC is partially determined by how that IC is used over the device's life. More specifically, the operating condition of the IC (e.g., its supply voltage) affects the magnitude of parameter drift. Therefore, it is desirable to know how various operating conditions will affect the performance of an IC over a certain period of time.

For obvious reasons testing an IC over a long period of time, say 10 years, is not feasible. Instead, it is generally known how to test a discrete transistor in a stressed condition over a relatively short period of time (e.g., a few hours or days) to simulate device behavior over longer periods of time. A similar accelerated test protocol can be used to test an entire IC. Testing an IC, however, is significantly more time consuming and costly than testing a discrete transistor and takes significantly more time, although still far less than the target multi-year period of time in question.

Accordingly, a better mechanism is needed to determine parameter drift due to NBTI of an IC over an extended period of time. Despite the advantages such a mechanism would provide, no such mechanism is known to exist today.

### BRIEF SUMMARY OF THE PREFERRED EMBODIMENTS OF THE INVENTION

The problems noted above are solved in large part by a method of correlating NBTI-induced integrated circuit performance degradation to discrete transistor NBTI-induced performance degradation and using that correlation to estimate integrated circuit NBTI-induced degradation over time using test results based on a discrete transistor. Because discrete transistors are easier and cheaper to test, the technique described herein makes it easier, faster and cheaper to estimate the degradation of an integrated circuit over time than testing the integrated circuit itself.

In accordance with a preferred embodiment of the invention, a method of predicting NBTI performance degradation of the integrated circuit over time includes at least the following three aspects. First, a relationship between NBTI induced degradation of an integrated circuit performance parameter and NBTI induced degradation of a discrete transistor performance parameter is computed. Then, the NBTI induced performance degradation for a discrete transistor performance parameter for a given operating condition of the transistor is determined. Next, the discrete transistor NBTI induced performance degradation determined for the given condition is used in the relationship computed between the integrated circuit and a discrete transistor to predict the NBTI induced degradation in the integrated circuit performance parameter. The integrated circuit performance parameter may be the part's maximum frequency or minimum operating voltage or any other relevant product performance parameter, while the transistor's performance parameter may be its drain saturation current or threshold voltage.

In accordance with another embodiment of the invention, a method of estimating the effects of NBTI on an integrated circuit comprises at least the following steps: (a) computing a relationship between NBTI induced degradation of an integrated circuit performance parameter and NBTI induced degradation of a discrete transistor performance parameter, wherein the relationship is computed for a first supply voltage, (b) obtaining a value representative of discrete transistor NBTI induced performance degradation for a second supply voltage, the second supply voltage being different than the first supply voltage, and (c) estimating the NBTI induced degradation of the integrated circuit performance parameter based on the relationship computed in (a) and the value obtained in (b).

Other variations on this method are possible and within the scope of this disclosure. These and other aspects of the preferred embodiments of the present invention will become apparent upon analyzing the drawings, detailed description and claims, which follow.

### BRIEF DESCRIPTION OF THE DRAWINGS

For a detailed description of the preferred embodiments of the invention, reference will now be made to the accompanying drawings in which:

FIG. 1 shows a method of determining a correlation between discrete transistor parameter drift and integrated circuit parameter drift in accordance with a preferred embodiment of the invention;

FIG. 2 shows an exemplary plot of drain saturation current drift for a discrete transistor of an integrated circuit over time;

FIG. 3 shows an exemplary plot of maximum frequency drift of an integrated circuit over time;

FIG. 4 shows a combination of the data in FIGS. 2 and 3 to correlate parameter drift in an IC with parameter drift in a discrete transition; and

FIG. 5 shows a method of performing an accelerated life test of a semiconductor device to determine parameter drift over time due to NBTI effects.

### NOTATION AND NOMENCLATURE

Certain terms are used throughout the following description and claims to refer to particular system components. As one skilled in the art will appreciate, semiconductor companies may refer to a component and sub-components by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either a direct or indirect electrical connection. Thus, if a first device couples to a second device, that connection may be through a direct electrical connection, or through an indirect electrical connection via other devices and connections. The term “integrated circuit” (also called a “chip”) is intended to refer two or more transistors formed on a semiconductor die. Typical ICs include thousands or even millions of transistors, although, unless otherwise specified, the term “integrated circuit” is not intended to signify any particular number of transistors on a die. To the extent that any term is not specially defined in this specification, the intent is that the term is to be given its plain and ordinary meaning.

### DETAILED DESCRIPTION OF THE PREFERRED EMBODIMENTS

Broadly, the preferred embodiment of the method described below permits NBTI induced degradation of an integrated circuit (IC) performance parameter to be predicted or estimated based on NBTI degradation data for a discrete transistor. The transistor at issue preferably is representative of the transistors forming the IC. That is, the transistor preferably is formed according to the same process as is used form the IC.

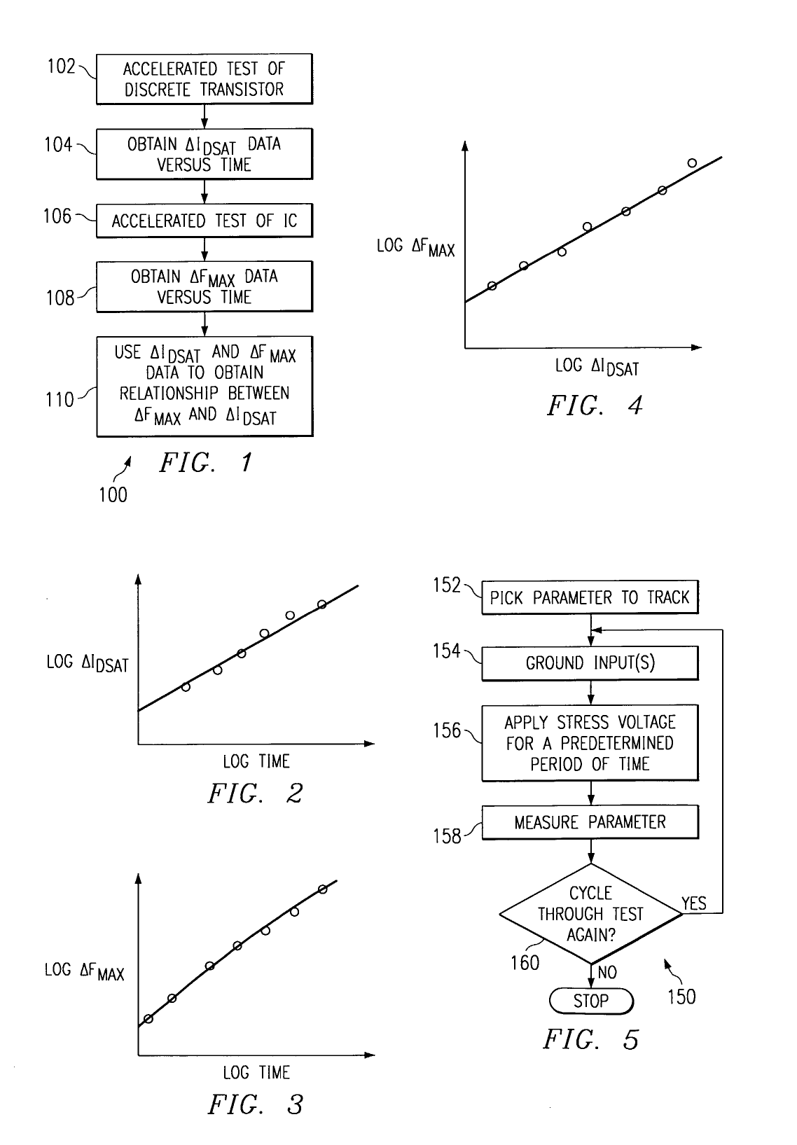

Referring now to FIG. 1, a method 100 is shown in accordance with a preferred embodiment of the invention. The method 100 generally includes steps 102-110, although the order is not significant. In step 102, a discrete transistor is put through an accelerated test in which NBTI is induced. A method of performing such an accelerated test will be discussed below with regard to FIG. 2. The NBTI inducing test is performed under a predetermined set of conditions including a particular supply voltage. The accelerated test serves to estimate the drift of a transistor parameter over a time period that is longer than the length of the test itself. For example, the test may take hours or a few days, but NBTI induced parameter drift is estimated for a period of time that is longer, such as months or years. The parameter tested can be any one of a variety of suitable parameters such as drain saturation current (Idsat).

As a result of the accelerated test performed in 102, the drift of the parameter being monitored for the transistor, for example Idsat, can be determined. An exemplary plot of the drift in Idsat for a discrete transistor is shown in FIG. 2. Because of the large time frame involved, the data is shown in a logarithmic format as would be understood by one of ordinary skill in the art. Further, the values plotted in FIG. 2, as well as in FIGS. 3 and 4, are plotted as the log of the change in the parameter as signified by the “Δ” symbol.

Referring still to FIG. 1, in step 106 an integrated circuit is run through a similar accelerated test as in step 102 for the discrete transistor and under the same set of conditions as was used in step 102. As a result of the accelerated test of step 106, the drift of an operational parameter pertaining to the integrated circuit can be estimated over time. The parameter tested can be any one of a variety of parameters including the maximum operating frequency (Fmax) in the case of a clocked IC (e.g., a processor) or the minimum operating voltage (Vmin).

As a result of the accelerated test performed in 106, the drift of the parameter being monitored for the IC, for example Fmax, can be determined. An exemplary plot of the drift in Fmax for the IC is shown in FIG. 3. Like the plot in FIG. 2, the plot in FIG. 3 also is shown on a logarithmic scale for convenience.

The Idsat for the transistor and the Fmax for the IC both reflect the drift in those parameters over the same time interval. Accordingly, the transistor's Idsat data and the IC's Fmax data can be combined together as indicated by step 110. A resulting exemplary plot of Delta Fmax versus Delta Idsat is shown in FIG. 4. The plot thus shows the relationship between the drift in a discrete transistor's Idsat parameter and the drift in an IC's Fmax parameter. This relationship between a discrete transistor and the IC can be used to predict the behavior of the IC over time. This point will be explained in further detail below. Before that, however, a preferred embodiment of the accelerated test discussed above will be described.

Referring now to FIG. 5, a preferred method 150 is shown by which a CMOS semiconductor device can be tested in a NBTI induced state to obtain parameter drift data over time. Test method 150 can be applied to a discrete transistor or an IC. The steps 152-160 comprising method 150 preferably are performed a relatively high temperature to help induce the NBTI effect, as is known. Any suitably high temperature can be used, such as 105 degrees centigrade. In step 152, a device parameter is picked for which it is desired to know the drift. As explained above, the parameter could be any desired transistor performance parameter, such as Idsat, or any desired IC parameter, such as Fmax or Vmin. In step 154, the device's inputs are grounded. In the context of a discrete transistor, the gate terminal is grounded, whereas in the context of an IC, the device's input signal lines are grounded and the device not clocked. This step places the device in a static mode in which state transitions will not occur.

Referring still to FIG. 5, a stress level voltage is applied to the device's power supply pins for a predetermined period of time. In the context of a discrete transistor, the stress voltage is applied to the transistor's drain terminal, whereas in the context of an IC, the stress voltage is applied to the device's power supply pins. The magnitude of the stress voltage preferably is higher than the nominal operating voltage, although it can be varied as desired. While the device's inputs are grounded and a stress supply voltage is applied and these conditions are performed at an elevated temperature, the device being tested experiences the effects of NBTI which causes parameter drift. The predetermined period of time during which the stress voltage is applied can be any suitable time period such as 30 minutes or one hour or more. At the end of the predetermined time period, the test conditions (heat, grounded inputs and clock input and stress voltage) are removed and the parameter at issue (Idsat, Fmax, etc.) is measured (step 158). Then, steps 154-158 are repeated and the parameter is thus measured over a plurality of time periods. The test continues for a predetermined number of cycles (step 160) until a desired amount of parameter data is obtained. The same or similar process is described in copending application entitled “Method for Measuring NBTI Degradation Effects on Integrated Circuits,” serial No. 60/316,523, incorporated herein by reference.

The following explanation describes how IC level degradation can be predicted using transistor level degradation data. As explained above, FIG. 4 represents the logarithmic relationship between an IC's Fmax degradation and a discrete transistor's Idsat degradation. As such, the amount of degradation in an IC's maximum frequency can be determined for a given degradation in transistor level Idsat. In accordance with the preferred embodiment of the invention, the degradation in an IC's performance (e.g., Fmax) is determined or estimated by first determining or estimating the degradation in performance of a transistor's Idsat over a given period of time. Then, once the transistor's Idsat is obtained, then the relationship between Idsat and Fmax (FIG. 4) is used to predict the degradation in performance of an IC.

The degradation in Idsat over time for a transistor depends on the operating conditions of the transistor, for example, the operating voltage. Often, a given transistor has already been accelerated tested for a particular operating condition over a desired time period. If so, that previously estimated Idsat degradation can be used. If not, in accordance with the preferred embodiment, a transistor made by the same process as the IC under consideration is put through an accelerated test as discussed above with reference to FIG. 5 under the desired operating condition. The operating condition, in fact, can be different from what was used to test a transistor initially to generate the relationship between IC Fmax and transistor Idsat (FIG. 4). At any rate, however the Idsat for the transistor is predicted or otherwise obtained, that value is used to predict the IC's Fmax degradation.

Accelerated testing is generally much faster, easier and less costly to perform on a discrete transistor than for an entire IC. Accordingly, IC performance degradation can be more cost effectively predicted in the method discussed above than performing an accelerated test of the IC itself for each set of operating conditions desired.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method of predicting negative bias temperature instability (NBTI) performance degradation of an integrated circuit over time, comprising:
(a) computing a relationship between NBTI induced degradation of an integrated circuit performance parameter and NBTI induced degradation of a discrete transistor performance parameter;
(b) determining the NBTI induced performance degradation for the discrete transistor performance parameter for a given operating condition of the transistor; and
(c) using the discrete transistor NBTI induced performance degradation determined in (b) in the relationship computed in (a) to predict the NBTI induced degradation in the integrated circuit performance parameter.

2. The method of claim 1 wherein the discrete transistor performance parameter in (a) is drain saturation current.

3. The method of claim 1 wherein the discrete transistor performance parameter in (a) is threshold voltage.

4. The method of claim 1 wherein the integrated circuit performance parameter in (a) is maximum operating frequency.

5. The method of claim 1 wherein the integrated circuit performance parameter in (a) is minimum operating voltage.

6. The method of claim 1 wherein (a) includes testing the transistor in a state in which NBTI is induced.

7. The method of claim 1 wherein (a) includes testing the integrated circuit in a state in which NBTI is induced.

8. The method of claim 1 wherein (a) includes testing the integrated circuit and the transistor in states in which NBTI is induced.

9. The method of claim 1 wherein (a) includes:
testing the integrated circuit in an NBTI mode;
determining the degradation of the integrated circuit's performance parameter over time;
testing the transistor in an NBTI mode under an operating condition;
determining the degradation of the transistor's performance parameter over time; and
combining the degradation of the integrated circuit's performance parameter with the transistor's performance parameter.

10. The method of claim 9 wherein (b) includes testing a transistor in an NBTI mode under an operating condition that is different from the operating condition used to test the transistor in (a).

11. The method of claim 1 wherein (a) includes testing a transistor in an NBTI mode under an operating condition and (b) includes testing a transistor in an NBTI mode under an operating condition that is different from the operating condition used to test the transistor in (a).

12. The method of claim 1 wherein (a) includes:
(a1) grounding input pins and clock input on the integrated circuit;
(a2) applying a stress voltage for a predetermined period of time;
(a3) measuring the integrated circuit performance parameter; and
(a4) repeating (a1)-(a3) at least once.

13. The method of claim 1 wherein (a) includes:
(a1) grounding the transistor's gate terminal;
(a2) applying a stress voltage to the integrated circuit's for a predetermined period of time;
(a3) measuring the integrated circuit performance parameter; and
(a4) repeating (a1)-(a3) at least once.

14. A method of estimating the effects of negative bias temperature instability (NBTI) on an integrated circuit, comprising:
(a) computing a relationship between NBTI induced degradation of an integrated circuit performance parameter and NBTI induced degradation of a discrete transistor performance parameter, said relationship computed for a first supply voltage;
(b) obtaining a value representative of discrete transistor NBTI induced performance degradation for a second supply voltage, said second supply voltage being different than said first supply voltage; and
(c) estimating the NBTI induced degradation of the integrated circuit performance parameter based on the relationship computed in (a) and the value obtained in (b).

15. The method of claim 14 wherein the integrated circuit performance parameter is maximum operating frequency and the transistor performance parameter is drain saturation current.

16. The method of claim 14 wherein the integrated circuit performance parameter is minimum operating voltage and the transistor performance parameter is drain saturation current.

17. The method of claim 14 wherein (a) includes:
applying heat to the integrated circuit and to the discrete transistor;
applying a DC stress voltage to the integrated circuit that causes NBTI to be induced in the integrated circuit; and
applying a DC stress voltage to the discrete transistor that causes NBTI to be induced in the transistor.
